(19) United States
(12) Patent Application Publication
(10) Pub. No.: US 2008/0196960 A1
(43) Pub. Date: Aug. 21, 2008

(54) SWINGARM ASSEMBLY

(76) Inventors: Duane Brown, Ravensdale, WA (US); Chris Brown, Auburn, WA (US); Brent Brown, Auburn, WA (US); Kurt Hall, Olympia, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/034,233

(22) Filed: Feb. 20, 2008

Related U.S. Application Data
(60) Provisional application No. 60/890,751, filed on Feb. 20, 2007.

(51) Int. Cl. B62K 25/04

(52) U.S. Cl. 180/227; 280/284; 280/281.1

(57) ABSTRACT

A swingarm and swingarm assembly for a rear wheel suspension are provided for a motorcycle or other two-wheeled vehicles, the swingarm having a pair of side spars attached to a cross member, the cross member having a seat formed therein to receive at least one of a plurality of mounting blocks having a yoke thereon for attachment to a shock absorber to provide a configurable swingarm assembly. Each mounting block has a different attachment point for the shock absorber to change the force vectors for the swingarm creating a softer or stiffer suspension for the rear wheel.

### BACKGROUND OF THE INVENTION

1. Field of the Invention

The present disclosure pertains to rear suspension systems for motorcycles and, more particularly, to a configurable swingarm assembly.

2. Description of the Related Art

Motorcycles, bicycles, and other two-wheeled vehicles utilize frames to support wheels, seats, and other components. Initial designs utilized solid one-piece frames without any provision for shock absorption. Thus, in these rigid-frame designs, the frame is directly connected to the rear wheel.

Improvements in frame designs incorporated telescoping front forks for shock absorption of the front wheel and a moveable swingarm for supporting the rear wheel assembly and associated suspension components. Design variations included a twin-shock suspension system holding the rear axle at one end of the swingarm to the frame while the other end of the swingarm was pivotally mounted to the frame. A single-sided swingarm has one arm to which the rear wheel is mounted. Later designs utilized a single shock or “monoshock” mounted to the frame and linked to the swingarm at a fixed attachment point on the swingarm.

With the fixed attachment between the frame and the swingarm, the shock absorption characteristics can only be altered by changing the shock absorber. While changing the swingarm is another option, it is much more difficult and complex because it requires removal of the rear wheel and associated drive train components. Hence, there is a need for a configurable swingarm that permits variation in attachment point of the shock absorber without requiring removal of the swingarm or the rear wheel and the drive train components.

### BRIEF SUMMARY OF THE INVENTION

The embodiments disclosed herein are directed to a configurable swingarm for use with motorcycles, bicycles, and the like. The swingarm includes, in one embodiment, replaceable mounting blocks having different leverage points that can be quickly replaced on the swingarm without requiring removal of the rear wheel, chain, or other drive train components.

In accordance with another embodiment of the invention, a swingarm is provided that includes a cross member and at least one side spar extending therefrom, the cross member having a saddle formed therein for receiving a mounting block. Ideally, a plurality of mounting blocks are provided, each mounting block including at least one yoke member for attachment to a shock absorber.

In accordance with another aspect of the foregoing embodiment, the yoke member on each of the mounting blocks comprises a pair of ears or tabs in spaced parallel relationship adapted to receive one end of a shock absorber for attachment thereto. Each mounting block including a plurality of openings aligned with openings in the cross member to received fasteners that attach the mounting block to the cross member on the swingarm.

In accordance with another embodiment, a swingarm assembly is provided that includes a swingarm having a cross member and a pair of side spars extending therefrom, and at least one mounting block adapted for attachment to the cross member.

In accordance with another aspect of the foregoing embodiment, the mounting block includes a body having first and second walls extending therefrom, and in one embodiment the walls define an angle between them in the range of 70° to 120°. The mounting block body further includes at least one yoke member extending therefrom for attachment to the shock absorber.

In accordance with another aspect of the foregoing embodiment, the cross member includes a seat adapted to receive the mounting block.

In accordance with another aspect of the foregoing embodiment, the assembly includes an axle mount slidably mounted on a distal end of each side spar and adapted to move in a longitudinal direction toward and away from a proximal end of the side spar.

In accordance with yet another aspect of the foregoing embodiment, the assembly includes an adjuster coupled to each spar arm and each axle mount to position and hold the axle mount relative to the spar arm.

In accordance with another aspect of the foregoing embodiment, the at least one attachment member is formed of a yoke having first and second tabs or ears extending therefrom, ideally in spaced parallel relationship.

In accordance with another aspect of the foregoing embodiment, each side spar includes an integral truss structure.

In accordance with another embodiment, a frame for a two-wheeled vehicle is provided, the frame including a subframe having a head tube, an engine mount, and a seat mount; and a swingarm assembly attached to the subframe, the swingarm assembly comprising: a swingarm having a cross member and a pair of side spars extending from the cross member; and at least one mounting block adapted for attachment to the cross member.

In accordance with another embodiment, a motorcycle is provided that includes a subframe having a head tube, an engine mount, and a seat mount; and a swingarm assembly attached to the subframe, the swingarm assembly comprising: a swingarm having a cross member and a pair of side spars extending from the cross member; at least one mounting block adapted for attachment to the cross member; and a shock absorber having one end attached to the at least one mounting block and a second end attached to the subframe.

As will be appreciated from the foregoing, the interchangeable mounting blocks enable a user to configure the suspension for a 70 pound youth or 225 pound adult without having to purchase and install new shocks. Different leverage blocks can be used for different track conditions. For example, a “stiff” block for a tight track riding style and a soft block for high speed long tracks where shock absorption is more critical for rider balance and stability.

### BRIEF DESCRIPTION OF THE SEVERAL VIEWS OF THE DRAWING(S)

The foregoing and other features and advantages of the present disclosure will be more readily appreciated as the same become better understood from the following detailed description when taken in conjunction with the accompanying drawings, wherein:

FIG. 1 is an isometric view of a swingarm formed in accordance with the present disclosure;

FIG. 2 is a top view of the swingarm assembly of FIG. 1;

FIG. 3 is a bottom view of the swingarm assembly of FIG. 1;

FIG. 4 is a front view of the swingarm assembly of FIG. 1;

FIG. 5 is a rear view of the swingarm assembly of FIG. 1;

FIG. 6 is a left-side view of the swingarm assembly of FIG. 1;

FIG. 7 is a right-side view of the swingarm assembly of FIG. 1; and

FIG. 8 is an isometric view of a swingarm and related components that form a swingarm assembly in accordance with the present disclosure;

FIG. 9 is an isometric view of the swingarm assembly of FIG. 1 attached to a subframe to form a frame assembly in accordance with the present disclosure;

FIG. 10 is an isometric view of a swingarm of FIG. 1;

FIG. 11 is a top plan view of the swingarm of FIG. 9;

FIG. 12 is a bottom plan view of the swingarm of FIG. 9;

FIG. 13 is a front plan view of the swingarm of FIG. 9;

FIG. 14 is a rear plan view of the swingarm of FIG. 9;

FIG. 15 is a left side view of the swingarm of FIG. 9; and

FIG. 16 is a right side view of the swingarm of FIG. 9.

### DETAILED DESCRIPTION OF THE INVENTION

Referring initially to FIG. 8, shown therein is a representative illustration of a swingarm assembly 10 formed in accordance with the present disclosure to include a swingarm 12 and a plurality of mounting blocks 14, 16, 18. One mounting block 18 is shown mounted to a cross member 20 that holds two side spars 22, 24 in spaced relationship. Ideally, the side spars 22, 24 are in spaced parallel relationship to one another.

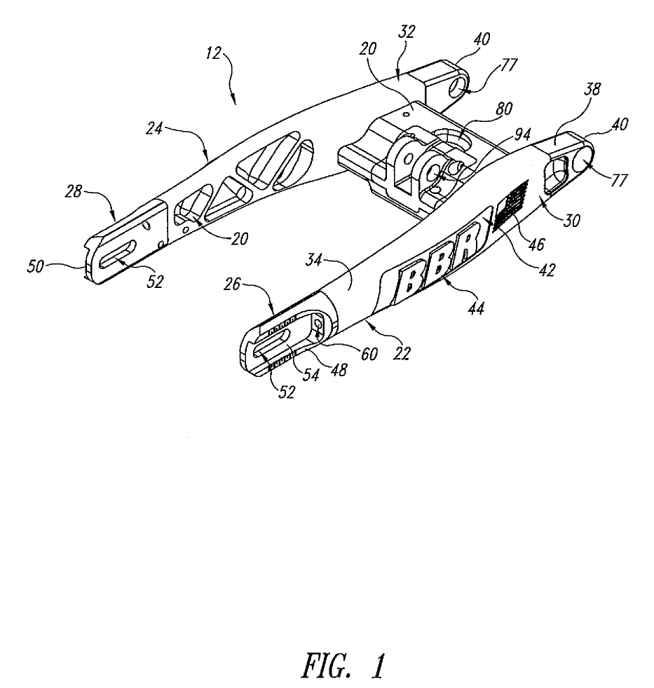

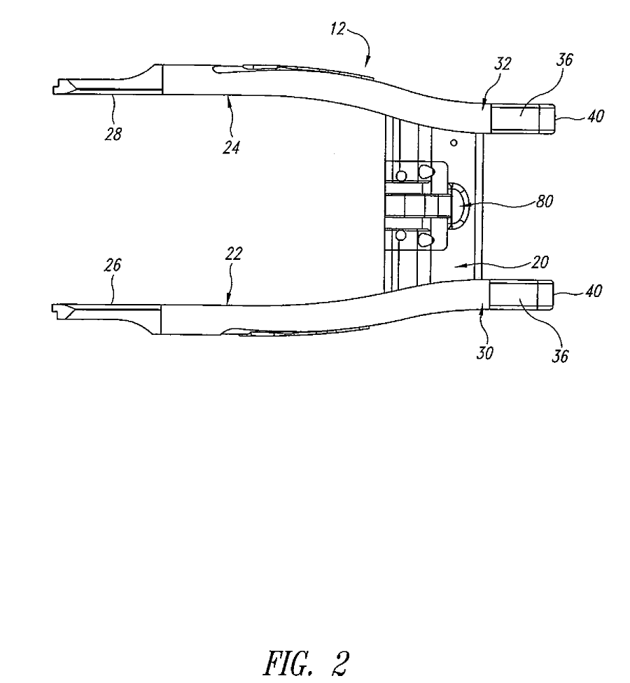

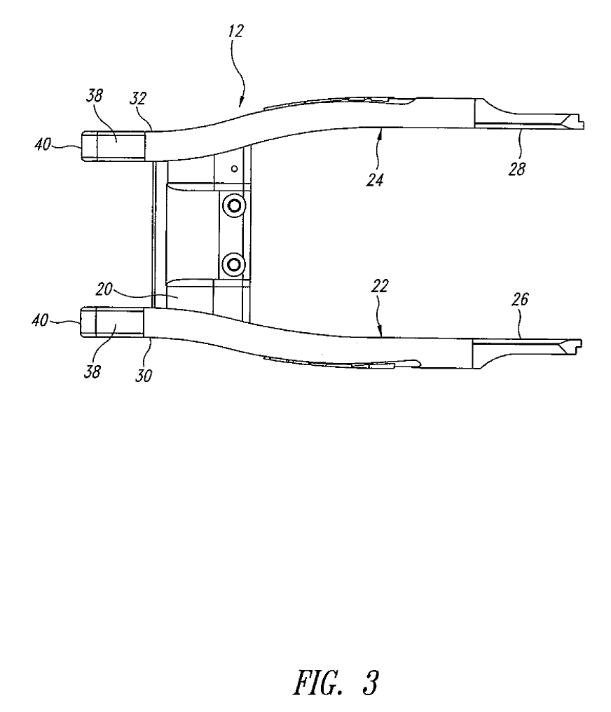

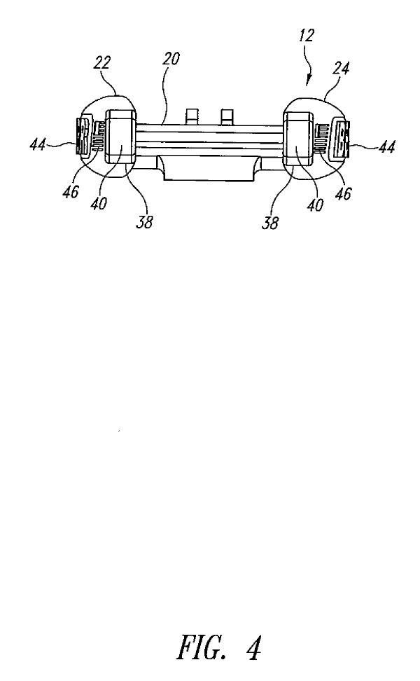

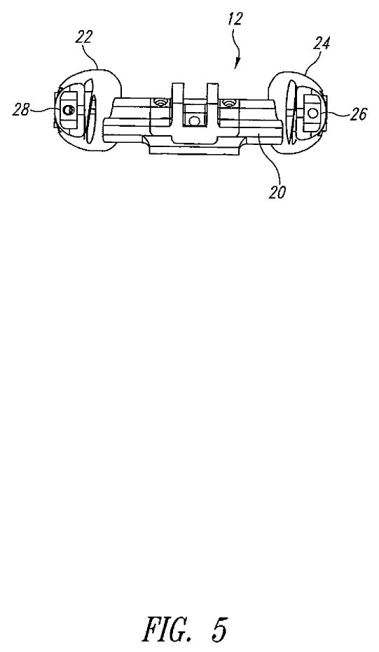

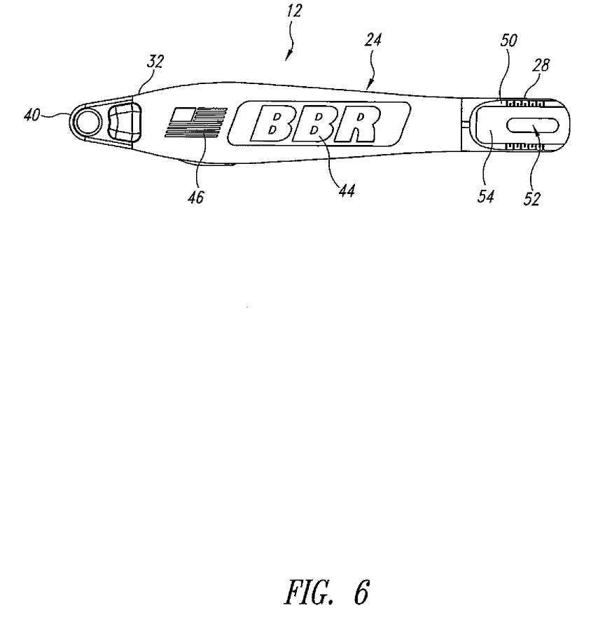

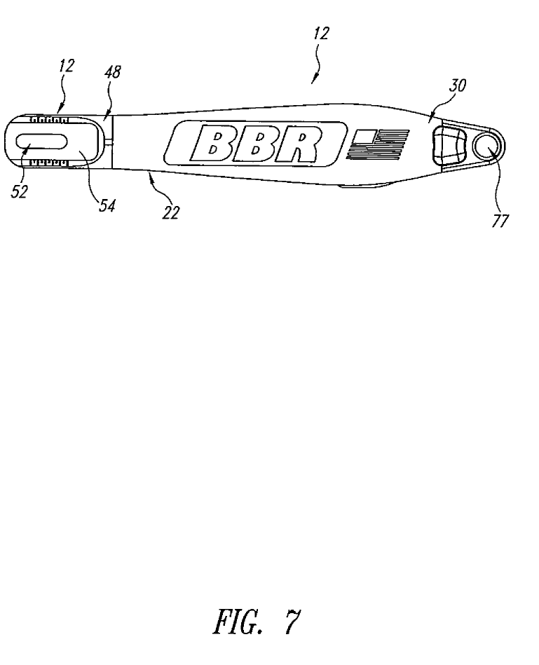

As shown in FIGS. 1-8, each side spar 22, 24 has an elongate configuration with a distal end 26, 28 and a proximal end 30, 32, respectively. The shape of each side spar 22, 24 as shown in FIG. 1 includes a number of cosmetic features, such as the curved exterior face 34 seen at the distal end of the right side spar 22 that transitions into a flat top surface 36 and bottom surface 38 that taper together at the proximal end 30 to form a rounded nose 40. In addition, the curved outside surface 34 at the distal end transitions into a flat side wall 42 toward the proximal end 30. The rounded corners along the top and bottom of the side spars 22, 24 and at the distal ends 26, 28, respectively, are ornamental and have no functional purpose. Moreover, surface ornamentation appearing on the side spars 22, 24, including the lettering “BBR” 44 in relief and the raised stripes and field 46 of the American flag are cosmetic only and do not affect the performance of the swingarm 10. It is to be understood that other shapes for the side spars 22, 24 can be used, such as straight side spars having a square or rectangular cross section, tubular side spars having a circular cross sectional configuration or oblong cross sectional configuration, and combinations of the foregoing and other known geometric shapes.

Each distal end 26, 28 of the side spars 22, 24 has a tapered flat section 48, 50 that is oriented vertically and includes an elongate opening 52 oriented parallel to a longitudinal axis of the side spars 22, 24.

As seen more clearly in FIG. 1, a planar seat 54 is formed on the outside surface of the flat section 48, 50 in which rides an axle mounting block 56 held in place by a threaded rod 58 that is threadably engaged with a longitudinal opening 60 formed in the side spar as shown in FIG. 1. Jam nuts 62 on each end of the threaded rod 58 hold the axle mounting block 56 in position on the side spar 22. The mounting block 56 has an “L” shape with the main body 64 formed to have a planar shape in which is formed a circular opening 66 that is aligned with the elongate opening 52 to receive the rear wheel axle mounting hardware. Orthogonal to the body 64 is the mounting wall 68 having a threaded opening that receives the rod 58.

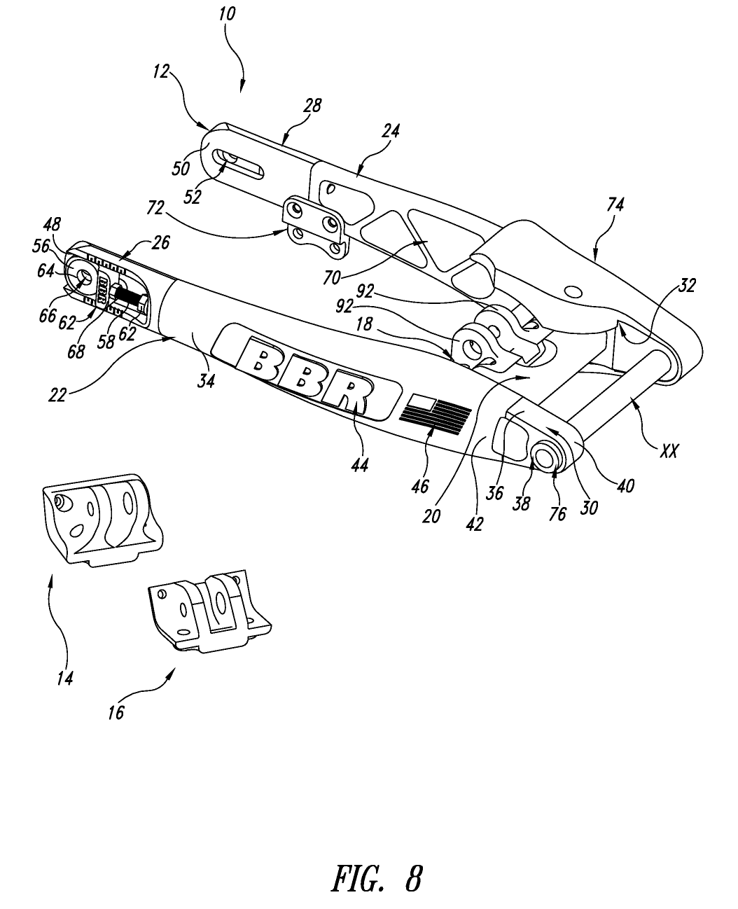

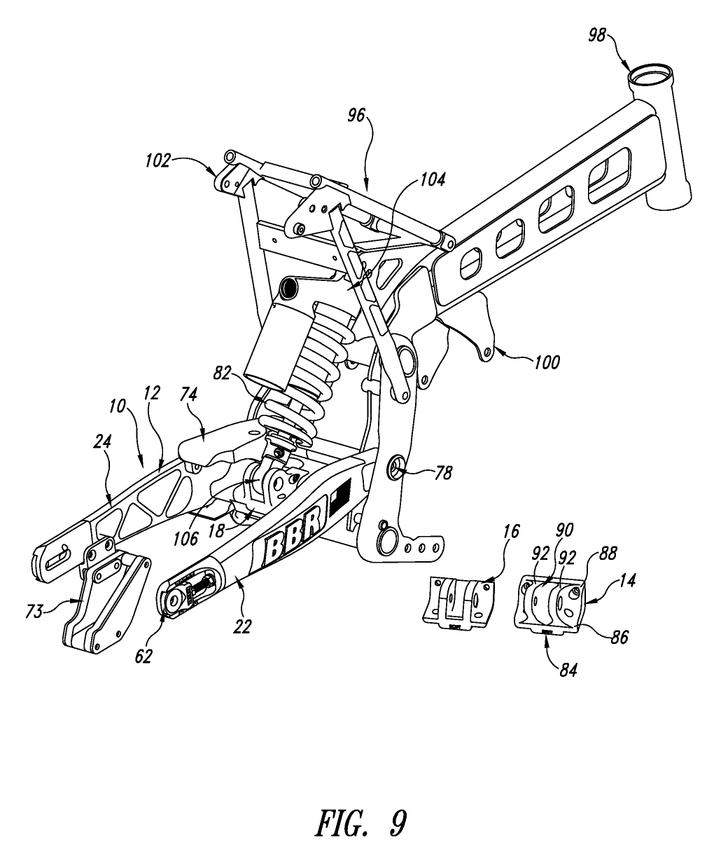

The interior side of each spar 22, 24 has a center section with an integral truss structure 70 formed therein. This structure 70 provides no greater rigidity than a solid section and, hence, is for ornamentation only. On the left spar 28, as shown in FIG. 8, is a chain guide mounting bracket 72 for a chain guide 73 as shown in FIG. 9. A chain protector 74 is mounted at the proximal end 32 of the left side spar 24. Bushings 76 are placed inside an opening 77 in the nose 40 of the proximal end 30, 32 of each side spar 22, 24. These bushings 76 are used to support rotation of the swingarm 12 around a mounting post 78, shown in FIG. 9. The cross member 20 is located distal of the proximal end 30, 32 of each side spar 22, 24 and includes a centrally disposed notch 80 as shown in FIG. 1 to provide clearance for the shock absorber 82 (shown in FIG. 9).

Each mounting block 14, 16, 18 includes a body 84 having first and second walls 86, 88 formed at roughly a 90° angle with respect to each other, although this angle can vary from 70° to 120°. The intersection of the walls 86, 88 is rounded on the exterior side to seat within a matching recess 89 in the cross member 20, and is rounded on the interior side on which is formed at least one yoke 90 for attachment to the shock absorber 82. In one embodiment shown in FIG. 8, the yoke 90 is formed of a pair of ears or tabs 92 extending away from the intersection of the walls 86, 88 in spaced, parallel relationship to each other. A transverse opening 94 is formed through each tab 92 to receive mounting hardware for the shock absorber 82. The position of the hole 94 can be varied from mounting block to mounting block to be closer to or farther away from the intersection of the walls 86, 88, but positioned on the same radius of the distance from the top shock absorber mount to the lower shock absorber mount. Each block 14, 16, 18, is easily attached to and detached from the cross member 20 via bolts, in this embodiment four bolts, two in each of the walls 86, 88 that are threadably engaged with threaded openings in the cross member 20.

In the embodiment shown in FIG. 9, the shock absorber blocks 14, 16, 18 are color coded to aid in selecting the desired level of stiffness. For example, the shock absorber block 14 is black, indicating it provides greater stiffness because the opening 94 is located more distal relative to the proximal ends of the side arms 22, 24 and further away from the intersection of the walls 86, 88 than the other block 18, which is blue to indicate a “medium” stiffness block. The third block 16 is red to indicate a “soft block” in that the hole is more proximal relative to the distal ends of the side arms 22, 24 and lower or closer to the intersection of the walls 86, 88. Thus, if a circle were drawn that intersected the top shock mount hole and extended around to the center of the lower shock mount hole, the openings 94 of the black, red, and blue mounting blocks 14, 16, 18, respectively, would lie on that circle but in different positions.

In one embodiment, the leverage ratio provided by the different blocks 14, 16, 18 changes by approximately 17% between each mounting block. For example, the black “stiff” block 14 moves the mounting point of the shock absorber 82 to a relatively lower position than the red block, and this lowers the leverage ratio of the swingarm 12 and to create a stiffer suspension angle for the shock absorber 82.

FIG. 9 shows the swingarm assembly 10 attached to a subframe assembly 96 that includes a head tube 98 for receiving a front wheel mounting assembly (not shown), a mounting block 100 for the engine (not shown), and mounting brackets 102 for a seat (not shown). The shock absorber 82 has a top end 104 mounted to the subframe assembly 96 and a lower end 106 attached to the blue mounting block 18.

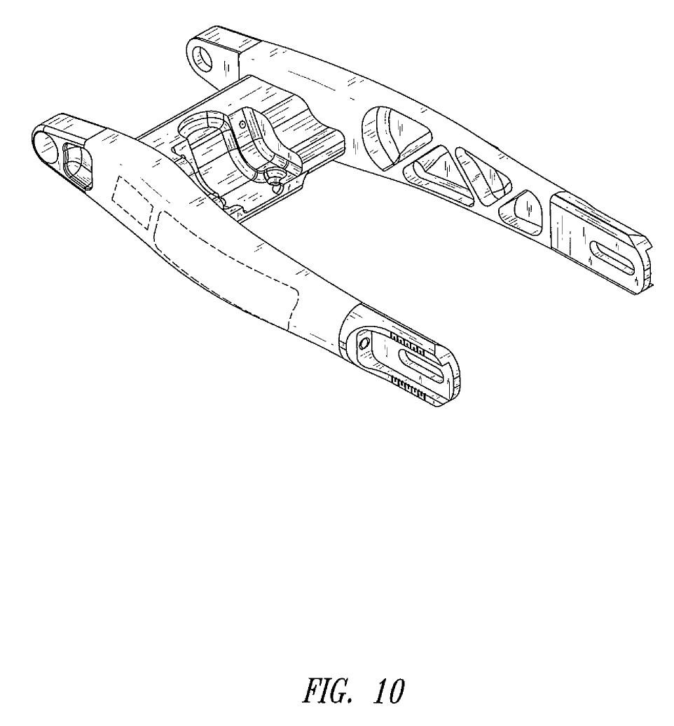

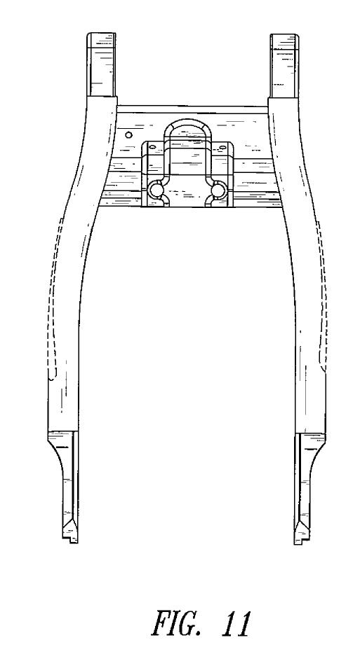

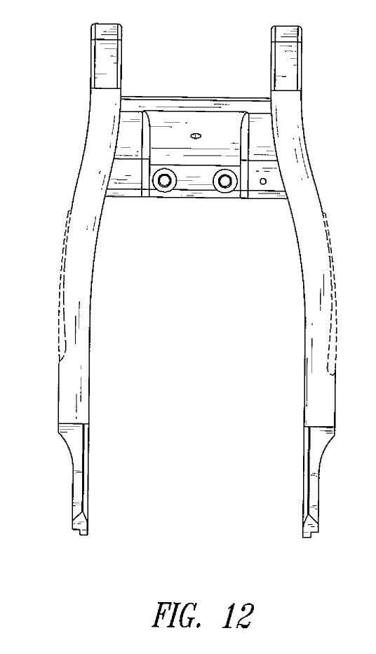

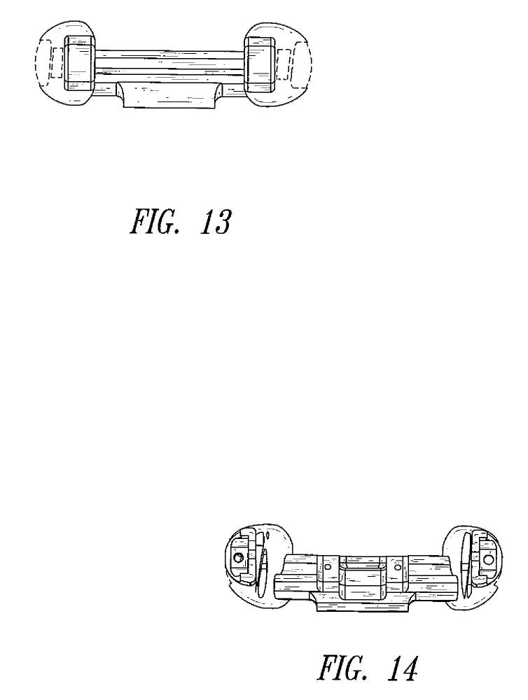

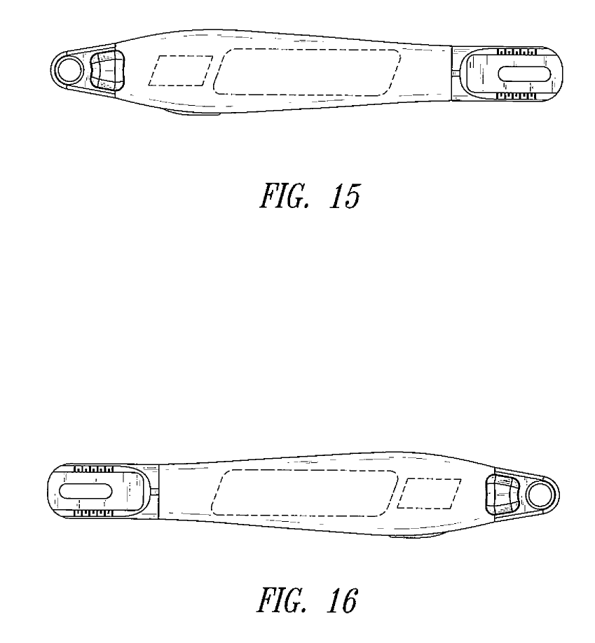

FIGS. 10-16 are illustrations of the swingarm without the block installed on the cross member 20. The recess 89 for the mounting block is seen more clearly in these views.

As will be readily appreciated from the foregoing, the present disclosure provides a swingarm with multiple mounting blocks that permit easy configuration of the rear suspension of a motorcycle as well as other two-wheeled vehicles. In the past, others have put multiple mounting holes on the top of the “frame” where the top of the shock absorber connects to the frame. This is inefficient because there is insufficient separation between the mounting positions to make a useful difference. In addition, disassembly of at least a portion of the rear suspension is necessary to change the bolt. With the present invention, only four bolts need to be removed and access is easy. The differences in the leverage blocks allow for a 17% change in leverage ratio of the swing arm to shock absorber combination, which provides substantial and noticeable changes.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A swingarm assembly, comprising:
a swingarm having a cross member and a pair of side spars extending from the cross member; and
a shock absorber mounting block adapted for removable attachment to the cross member.

2. The assembly of claim 1 wherein the mounting block comprises a body having first and second walls extending therefrom at an angle between them in the range of 75° to 120°, the body further having a yoke member extending therefrom.

3. The assembly of claim 1 wherein the cross member comprises a seat adapted to receive the mounting block.

4. The assembly of claim 1, further comprising an axle mount slidably mounted on a distal end of each side spar and adapted to move in a longitudinal direction toward and away from a proximal end of the side spar.

5. The assembly of claim 4, comprising an adjuster coupled to each side spar and each axle mount to position and hold the axle mount relative to the side spar.

6. The assembly of claim 2 wherein the at least one yoke member comprises first and second tabs extending from the body in spaced parallel relationship.

7. The swingarm assembly of claim 1, comprising a plurality of mounting blocks, each mounting adapted for removable attachment to the cross member, and each mounting block having at least one yoke member extending therefrom and including an attachment point, wherein each mounting block is configured to have the attachment point positioned at a location that is different from the locations of the attachment points on the other mounting blocks to provide a different shock absorber leverage point on the swingarm.

8. A frame assembly for a two-wheeled vehicle, the frame assembly comprising:
a subframe having a head tube, an engine mount, and a seat mount; and
a swingarm assembly attached to the subframe, the swingarm assembly comprising:
a swingarm having a cross member and a pair of side spars extending from the cross member; and
at least one shock absorber mounting block adapted for removable attachment to the cross member.

9. The assembly of claim 8 wherein the mounting block comprises a body having first and second walls extending therefrom, the first and second walls having an angle between them in the range of 75° to 120°, the body further having a yoke member extending therefrom.

10. The assembly of claim 8 wherein the cross member comprises a seat adapted to receive the mounting block.

11. The assembly of claim 8, further comprising an axle mount slidably mounted on a distal end of each side spar and adapted to move in a longitudinal direction toward and away from a proximal end of the side spar.

12. The assembly of claim 11, comprising an adjuster coupled to each side spar and each axle mount to position and hold the axle mount relative to the side spar.

13. The assembly of claim 9 wherein the at least one yoke member comprises first and second tabs extending from the body in spaced parallel relationship.

14. A motorcycle, comprising:
a subframe having a head tube, an engine mount, and a seat mount; and
a swingarm assembly attached to the subframe, the swingarm assembly comprising:
a swingarm having a cross member and a pair of side spars extending from the cross member;
at least one shock absorber mounting block adapted for attachment to the cross member; and
a shock absorber having one end attached to the at least one mounting block and a second end attached to the subframe.

15. The assembly of claim 14 wherein the mounting block comprises a body having first and second walls extending therefrom, the first and second walls having an angle between them in the range of 75° to 120°, the body further having a yoke member extending therefrom.

16. The assembly of claim 14 wherein the cross member comprises a seat adapted to receive the mounting block.

17. The assembly of claim 14, further comprising an axle mount slidably mounted on a distal end of each side spar and adapted to move in a longitudinal direction toward and away from a proximal end of the side spar.

18. The assembly of claim 17, comprising an adjuster coupled to each side spar and each axle mount to position and hold the axle mount relative to the side spar.

19. The assembly of claim 15 wherein the at least one yoke member comprises first and second tabs extending from the body in spaced parallel relationship.
